(19) United States
(12) Patent Application Publication
(10) Pub. No.: US 2012/0240775 A1
(43) Pub. Date: Sep. 27, 2012

(54) LOCKING STRUCTURE OF INFUSION BARREL FOR BEVERAGE MAKING DEVICE

(76) Inventor: DANIEL YANG, TAOYUAN COUNTY (TW)

(21) Appl. No.: 13/052,320

(22) Filed: Mar. 21, 2011

(51) Int. Cl. A47J 31/44; E05C 3/04

(52) U.S. Cl. 99/279; 292/195

(57) ABSTRACT

A locking structure of an infusion barrel for a beverage making device includes a barrel having a protrusion portion and a first pivotal portion. The protrusion portion has a shaft pivotably connected with a locking member and a first resilient member. The first resilient member has a first end fixed to the protrusion portion and a second end contacting the locking member. A cover includes a protrusion and a second pivotal portion. An axle extends through the second pivotal portion and the first pivotal portion of the barrel to pivotably connect the cover to the barrel. The protrusion has an engaging member which is located corresponding to the locking member of the barrel. The cover is easily connected with the barrel.

### FIELD OF THE INVENTION

The present invention relates to a locking structure of an infusion barrel for a beverage making device, and more particularly, to a dual-locking structure for connecting the barrel and the cover.

### BACKGROUND OF THE INVENTION

A conventional beverage making device uses pressurized water and steam to stir the water level to shorten the time required for making beverage so that the pressure in the barrel is significant. If the locking structure is too weak, the pressure may open the cover suddenly and cause dangerous results. Taiwan Patent Publish No. M319010 discloses a barrel, a cover and a locking unit, wherein the barrel has a protrusion on the front end thereof and a pivotal portion is formed on the rear end of the barrel. The cover is located on the barrel and has a pivotal member. A first pin extends through the pivotal member and the pivotal portion to pivotably connect the barrel and the cover. The locking unit is fixed to the front end of the cover by a locking member which is pivotably connected with a lever by a second pin. The lever is connected with a slide piece by a third pin. A locking rod is located on a side of the lever so as to be in contact with the underside of the protrusion of the cover. A handle is fixed to the underside of lever.

By operation of the handle to pivot the lever to engage the barrel and the cover, but it requires significant force. When opening the cover, the user has to pivot the cover backward by using the handle. However, the beverage is hot and steam is in the barrel so that when the cover is opened, the steam releases and may burn the user's hand.

The present invention intends to provide a locking structure for connecting the cover to the barrel so as to improve the drawback of the conventional beverage making device.

### SUMMARY OF THE INVENTION

The present invention relates to a locking structure of an infusion barrel for a beverage making device, and comprises a barrel having a protrusion portion and a first pivotal portion. The protrusion portion has a shaft which is pivotably connected with a locking member and a first resilient member. The first resilient member has a first end and a second end, wherein the first end is fixed to the protrusion portion and the second end contacts the locking member. A cover is located on the barrel and has a protrusion and a second pivotal portion. An axle extends through the second pivotal portion and the first pivotal portion of the barrel to pivotably connect the cover to the barrel. The axle has at least one second resilient member which has a third end and a fourth end, wherein the third end is fixed to the barrel and the fourth end contacts the cover. The protrusion has an engaging member located corresponding to the locking member of the barrel.

The locking member has a first inclined surface and the engaging member has a second inclined surface which is located corresponding to the first inclined surface.

The shaft of the protrusion portion extends from the protrusion portion and two pins extend from two sides of the protrusion of the cover. The two pins are pivotably connected with a hooking member which has two hooks located corresponding to the shaft of the protrusion portion and engaged with the shaft.

The protrusion portion has two slots which communicate the shaft. The two hooks of the hooking member are inserted into the slots and hooked to the shaft.

The locking member has a first inclined surface and the engaging member has a second inclined surface which is located corresponding to the first inclined surface. When the user pushes the cover, the second inclined surface is engaged with the first inclined surface to connect the cover to the barrel. The operation is completed without too much force. The first resilient member returns the locking member so that the user can operate the cover by one hand.

The cover has a locking member which is hooked to the shaft of the protrusion portion of the barrel so as to prevent the cover from disengaging from the engaging member by unintentionally touching the locking member.

The axle has the second resilient member mounted thereto which is biased between the barrel and the cover, so that when the cover is closed, the second resilient member is in compressed status. When the cover is opened, the second resilient member automatically opens the cover.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view of the present invention;

FIG. 2 is a cross sectional view to show that the cover is located at angle from the barrel because of the second resilient member;

FIG. 3 shows that the second inclined surface of the engaging member is engaged with the first inclined surface of the locking member;

FIG. 4 shows that the cover on the barrel is closed;

FIG. 5 shows that the hooks of the hooking member are inserted into the slots and hook to the shaft of the protrusion portion, and

FIG. 6 shows another embodiment wherein the hooks of the hooking member are directly hooked to the shaft of the protrusion portion.

### DETAILED DESCRIPTION OF THE PREFERRED EMBODIMENT

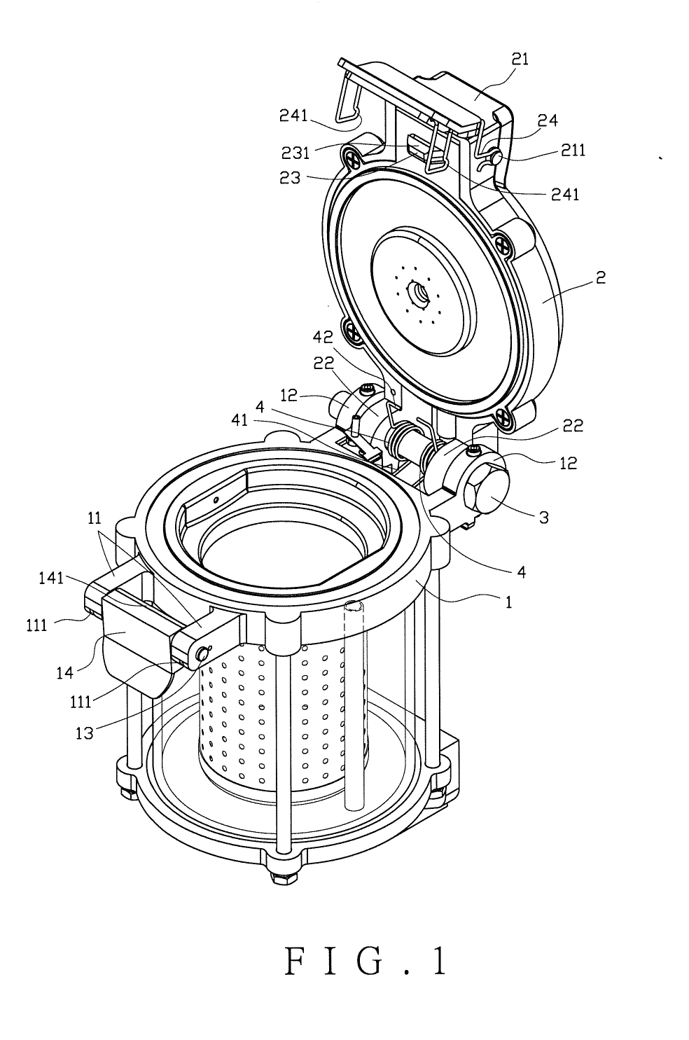

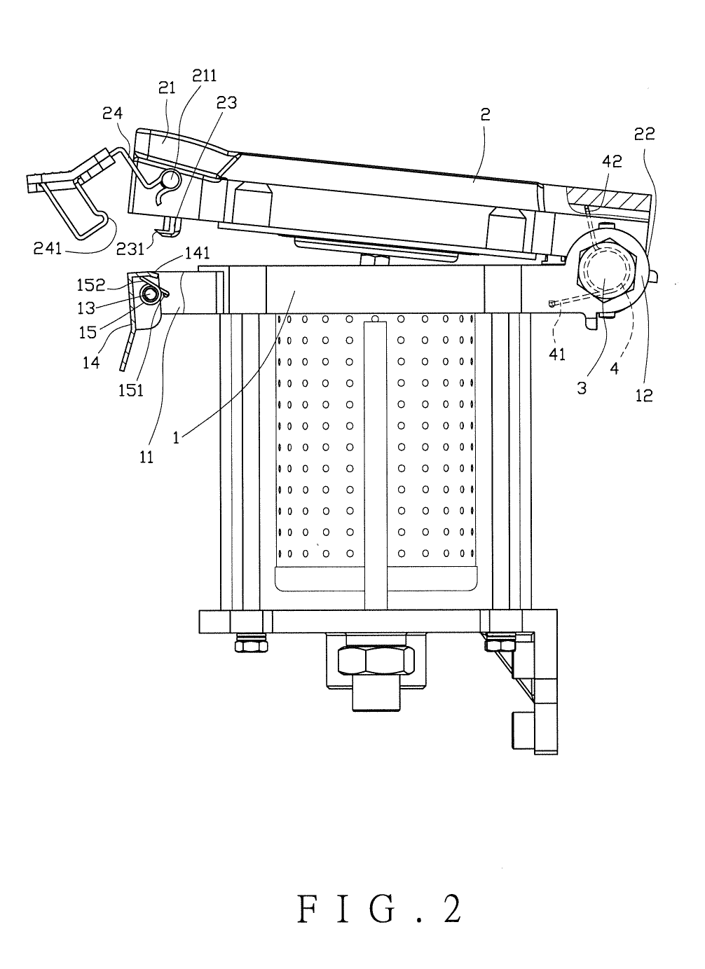

Referring to FIGS. 1 and 2, the infusion barrel for a beverage making device of the present invention comprises a barrel 1 and a cover 2. The barrel 1 has a protrusion portion 11 and a first pivotal portion 12. The protrusion portion 11 has a shaft 13 which is pivotably connected with a locking member 14 and a first resilient member 15. The first resilient member 15 has a first end 151 and a second end 152, wherein the first end 151 is fixed to the protrusion portion 11 and the second end 152 contacts the locking member 14. The locking member 14 has a first inclined surface 141. The shaft 13 of the protrusion portion 11 of the barrel 1 protrudes from the protrusion portion 11.

The cover 2 is located on the barrel 1 and has a protrusion 21 and a second pivotal portion 22. An axle 3 extends through the second pivotal portion 22 and the first pivotal portion 12 of the barrel 1 to pivotably connect the barrel 1 to the cover 2. The protrusion 21 has an engaging member 23 located corresponding to the locking member 14 of the barrel 1. The engaging member 23 has a second inclined surface 231 which is located corresponding to the first inclined surface 141 of the locking member 14. Two pins 211 extend from two sides of the protrusion 21 of the cover 2. The two pins 211 are pivotably connected with a hooking member 24 which has two hooks 241. The protrusion portion 11 has two slots 111 which communicate the shaft 13. The two hooks 241 of the hooking member 24 are inserted into the slots 111 and hooked to the shaft 13.

The axle 3 has at least one second resilient member 4 which has a third end 41 and a fourth end 42. The third end 41 is fixed to the barrel 1 and the fourth end 42 contacts the cover 2.

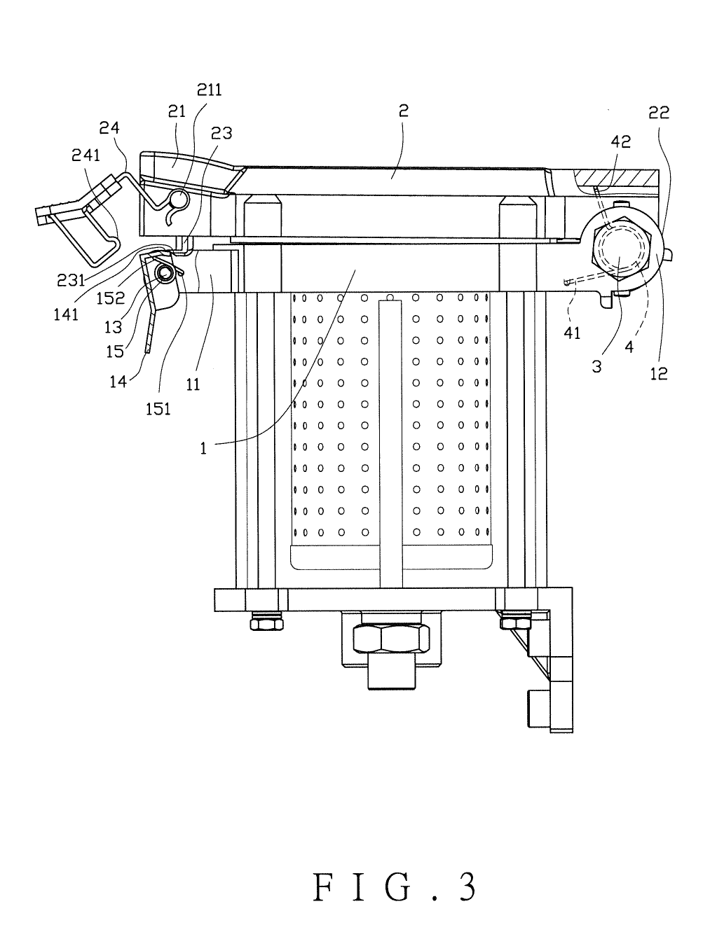

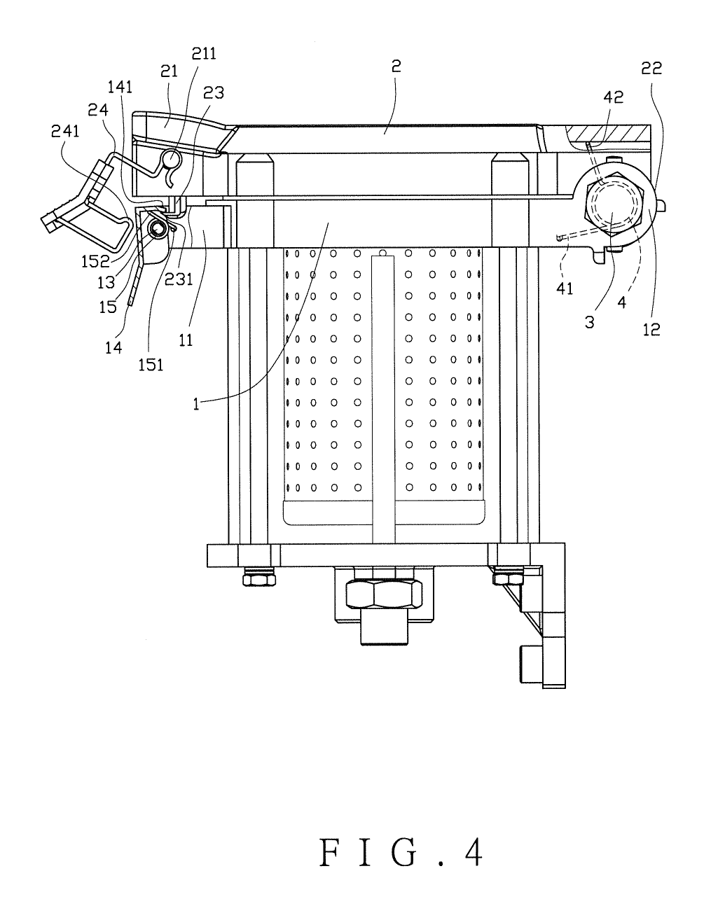

When in operation, as shown in FIGS. 3 and 4, the cover 2 is pushed and the second inclined surface 231 of the engaging member 23 of the cover 2 pushes the first inclined surface 141 of the locking member 14. The locking member 14 compresses the second end 152 of the first resilient member 15, and the engaging member 23 contacts the locking member 14 to close the cover 2 onto the barrel 1. This action can be completed by one hand without too much force. As shown in FIG. 4, when the engaging member 23 and the locking member 14 are well positioned, the force that the engaging member 23 applies to the locking member 14 is disappeared, the second end 152 of the first resilient member 15 generates a return force to make the locking member 14 firmly press the engaging member 23 so that it is convenient to use for the users.

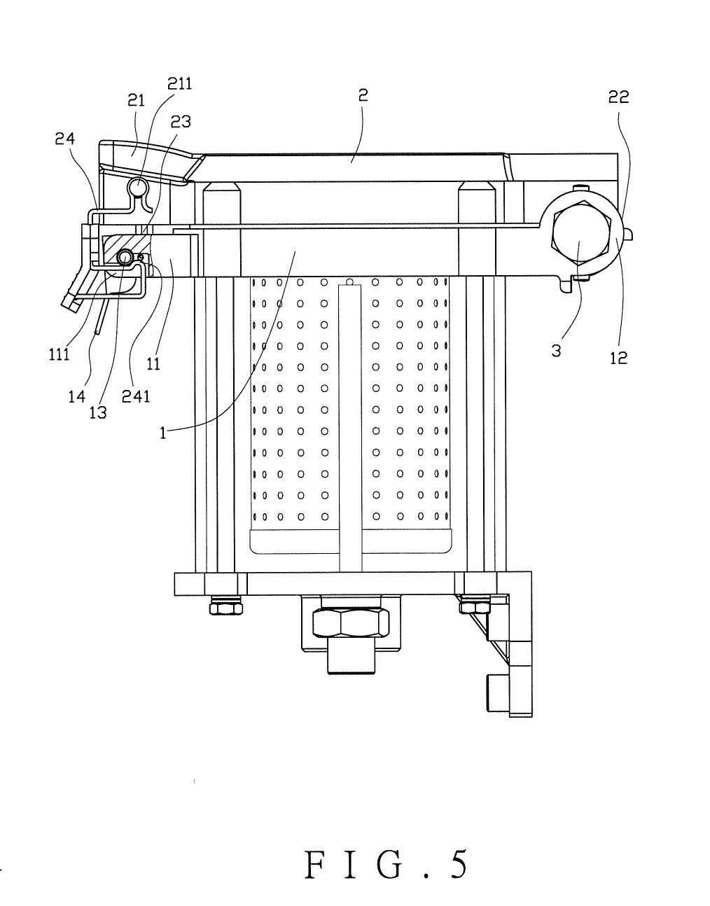

As shown in FIG. 5, when the engaging member 23 is engaged with the locking member 14, the hooking member 24 of the cover 2 is pivoted downward and the two hooks 241 are inserted into the slots 111 of the protrusion portion 11 and hook to the shaft 13 of the protrusion portion 11. By the hooking action, the engaging member 23 of the cover 2 is not disengaged from the locking member 14 even if the locking member 14 is unintentionally touched. It is noted that when making the beverage, if the cover is unexpectedly opened, the steam will injure the users so that by the second stage of locking action, the cover 2 is well locked to the barrel 1.

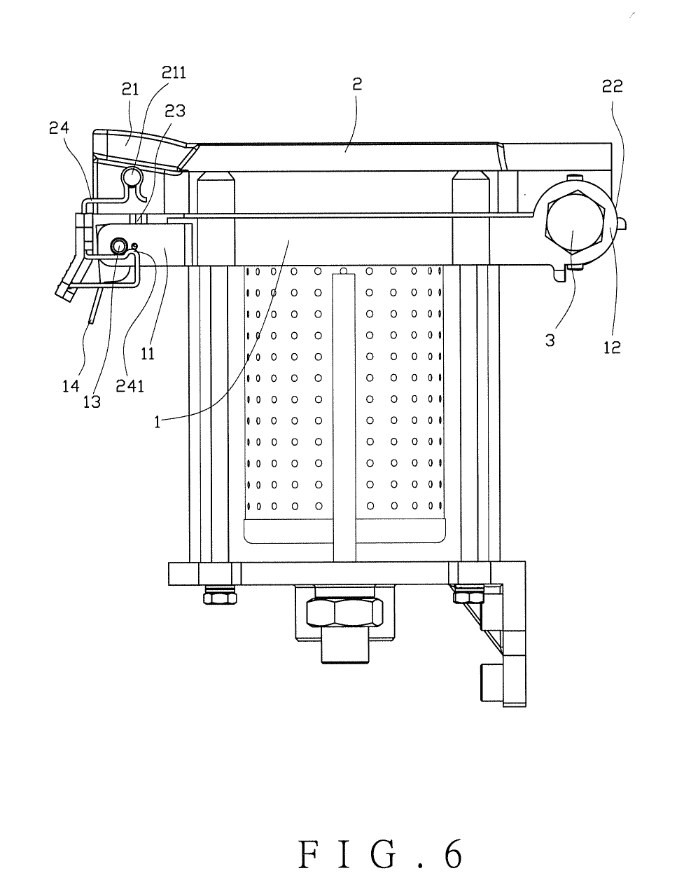

As shown in FIG. 6 which shows another embodiment of the engagement of the hooks 241 and the shaft 13, the shaft 13 protrudes from the protrusion portion 11 to form a protrusion as shown in FIG. 1 and the hooks 241 of the hooking member 24 directly hook to the shaft 13.

Referring to FIGS. 2 to 4 again, the force of the second resilient member 4 makes the cover 2 open an angle relative to the barrel 1 as shown in FIG. 2. When the cover 2 is pushed as shown in FIGS. 3 and 4, the cover 2 compresses the fourth end 42 of the second resilient member 4 so that the second resilient member 4 is compressed until the cover 2 is completely closed on the barrel 1. In other words, the fourth end 42 of the second resilient member 4 is compressed between the cover 2 and the barrel 1, so that when the user pushes the locking member 14, the fourth end 42 of the second resilient member 4 generates a return force to automatically open the cover 2 so that the users are not injured by the steam when the cover 2 is opened.

While we have shown and described the embodiment in accordance with the present invention, it should be clear to those skilled in the art that further embodiments may be made without departing from the scope of the present invention.

What is claimed is:

1. A locking structure of an infusion barrel for a beverage making device, comprising:
a barrel having a protrusion portion and a first pivotal portion, the protrusion portion having a shaft which is pivotably connected with a locking member and a first resilient member, the first resilient member having a first end and a second end, the first end fixed to the protrusion portion and the second end contacting the locking member, and
a cover located on the barrel and having a protrusion and a second pivotal portion, an axle extending through the second pivotal portion and the first pivotal portion of the barrel to pivotably connect the cover to the barrel, the axle having at least one second resilient member which has a third end and a fourth end, the third end fixed to the barrel and the fourth end contacting the cover, the protrusion having an engaging member located corresponding to the locking member of the barrel.

2. The locking structure as claimed in claim 1, wherein the locking member has a first inclined surface and the engaging member has a second inclined surface which is located corresponding to the first inclined surface.

3. The locking structure as claimed in claim 1, wherein the shaft of the protrusion portion extends from the protrusion portion and two pins extend from two sides of the protrusion of the cover, the two pins are pivotably connected with a hooking member which has two hooks located corresponding to the shaft of the protrusion portion and engaged with the shaft.

4. The locking structure as claimed in claim 3, wherein the protrusion portion has two slots which communicate the shaft, the two hooks of the hooking member are inserted into the slots and hooked to the shaft.
